(19) United States
(12) Patent Application Publication
(10) Pub. No.: US 2005/0103597 A1
(43) Pub. Date: May 19, 2005

(54) Sorting device and method for flat objects

(75) Inventor: Michele Scarnera, Genova (IT)

Correspondence Address: Howrey Simon;Arnold & White, 750 Bering Drive, Houston, TX, 77057-2198, US

(73) Assignee: ELSAG S.P.A., GEOVA (IT)

(21) Appl. No.: 10/484,461

(22) PCT Filed: Jul. 22, 2002
(86) PCT No.: PCT/IT02/00485

(30) Foreign Application Priority Data
Jul. 20, 2001 (IT) TO2001A000716

(51) Int. Cl. B07C 3/08

(52) U.S. Cl. 198/370.01

(57) ABSTRACT

A device for loading, conveying, and sorting substantially flat items (FLATS), in particular mail items (3), having a number of item receptacles (18) traveling along an endless path (7) between a loading area (10), where a substantially flat item (3) is fed into each item receptacles (18), and an unloading area (12), where the substantially flat items in the item receptacles (18) are released selectively. Each item receptacle (18) has an inner cavity (26) for housing the substantially flat item (3), and which communicates with the outside through at least one rectangular elongated opening (30) positioned with its major sides substantially aligned with a first traveling direction (D). The device also has a feed device (50) for feeding the substantially flat item (3) in a second direction (F) crosswise to the first direction (D), so that the substantially flat item is fed into the inner cavity (26) through the elongated opening (30), with leading edges of the substantially flat item substantially parallel to the major sides of the elongated opening (30).

### TECHNICAL FIELD

The present invention relates to a device and method for loading, conveying, and sorting substantially flat items (FLATS), in particular mail items.

### BACKGROUND ART

Devices for loading, conveying, and sorting substantially flat items, in particular mail items, are known in which a number of loading units travel along an endless path to convey the items between one or more loading areas, where the items are fed singly into the loading units, and one or more unloading areas, where the items in the loading units are released selectively to conveying containers and/or systems.

The term “substantially flat items” is intended to mean any items (e.g. letters, postcards, enclosed documents, boxes, magazines and newspapers with or without a protective cover) having two dimensions which are predominant with respect to the third.

Known loading units normally comprise a casing defining an inner cavity which communicates with the outside of the loading unit through an inlet opening through which the substantially flat item is inserted.

Known sorting devices provide at best for a throughput of roughly 40,000 items/hour, which cannot be increased further without necessarily increasing the linear traveling speed of the loading units along the path. Increasing speed, however, increases the likelihood of the end edges of the substantially flat items, as they are inserted through the inlet opening, striking the parts of the loading unit defining the inlet opening, in which case, the item normally bounces off or crumples, or at any rate is not deposited inside the loading unit.

### DISCLOSURE OF INVENTION

It is an object of the present invention to provide a device for loading, conveying, and sorting substantially flat items, in particular mail items, designed to eliminate the drawbacks of known devices, and which provides for high hourly throughput rates.

According to the present invention, there is provided a device for loading, conveying, and sorting substantially flat items (FLATS), in particular mail items, as claimed in Claim 1.

The present invention also relates to a method of loading, conveying, and sorting substantially flat items (FLATS), in particular mail items, as claimed in Claim 19.

### BRIEF DESCRIPTION OF THE DRAWINGS

A preferred, non-limiting embodiment of the invention will be described by way of example with reference to the accompanying drawings, in which:

FIG. 1 shows a schematic view in perspective of a device for loading, conveying, and sorting substantially flat items (FLATS), in particular mail items, in accordance with the teachings of the present invention;

FIG. 2 shows a larger-scale view of a detail of the FIG. 1 device in a first operating position;

FIG. 3 shows the FIG. 2 detail in a second operating position;

FIG. 4 shows a side view of a subassembly of the FIG. 1 device;

FIG. 5 shows a view in perspective of a variation of the FIG. 1 device.

### BEST MODE FOR CARRYING OUT THE INVENTION

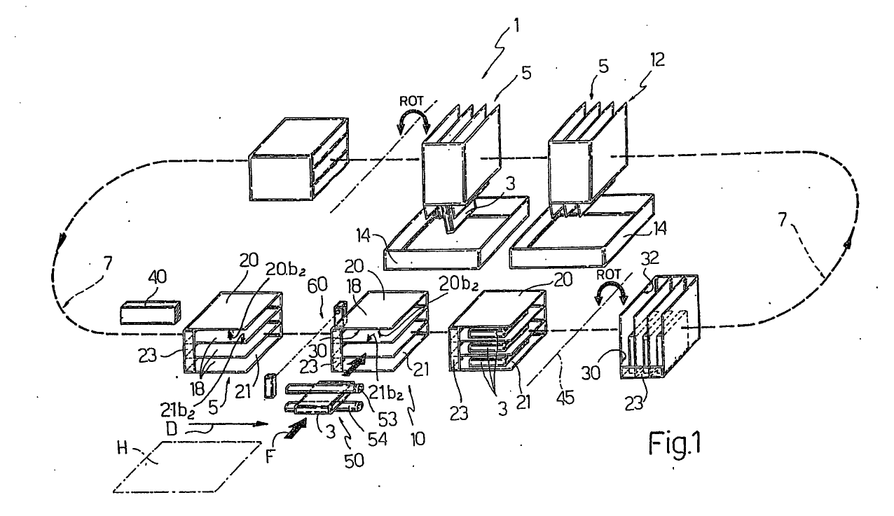

Number 1 in FIG. 1 indicates as a whole a device for loading, conveying, and sorting substantially flat items (FLATS), in particular mail items.

The term “substantially flat item (FLAT)” is intended to mean any (e.g. parallelepiped-shaped) item having two dimensions which are predominant with respect to the third.

More specifically, device 1 may be used to advantage for processing substantially flat mail items 3 such as letters, postcards, enclosed documents, boxes, magazines and newspapers with a protective cover, etc.

Device 1 comprises a number of conveying units 5 which are moved by drive means (not shown) along an endless path 7 between at least one loading area 10, where items 3 are fed to units 5, and at least one unloading area 12, where items 3 in conveying units 5 are released into unloading containers 14.

It should be pointed out that the circular endless path 7 shown schematically in FIG. 1 and lying in one plane is intended purely as a simplified example, and that path 7 may be of any shape and even extend in a number of planes. Similarly, items 3 may be unloaded into loading units (not shown) forming part of conveying systems (not shown) for receiving and conveying items 3 released by units 5.

Each conveying unit 5 comprises a number of loading units 18 arranged side by side in a stack structure, and each for receiving, housing, and conveying a substantially flat item 3.

More specifically, each loading unit 18 comprises a first rectangular wall 20; and a second rectangular wall 21 parallel to first wall 20 and connected to it by a first rectangular spacer wall 22 extending integrally along the whole length of first major edges 20b₁, 21b₁ of walls 20, 21, and by a second rectangular spacer wall 23 extending integrally along respective portions of second major edges 20b₂, 21b₂, opposite the first edges, of walls 20, 21.

Walls 20, 21, 22, 23 define a parallelepiped-shaped cavity 26 which communicates with the outside through a first rectangular inlet opening 30 defined by the free portions of second edges 20b₂, 21b₂ of walls 20, 21, and by an edge 23b of rectangular spacer wall 23. Wall 23 may even be dispensed with.

Parallelepiped-shaped cavity 26 also communicates with the outside through a second rectangular opening 32 defined by free third edges 20b₃, 21b₃ of walls 20, 21 adjacent and perpendicular to second edges 20b₂, 21b₂, and by an edge 22b of rectangular spacer wall 22.

Rectangular openings 30 and 32 are therefore adjacent and lie in two perpendicular planes.

In any operating condition of device 1, rectangular openings 30 and 32 also connect parallelepiped-shaped cavity 26 to the outside of loading unit 18.

Loading unit 18 also defines a third rectangular unloading opening 33 on the opposite side to opening 32 and having a flat rectangular lid 35 hinged to wall 21.

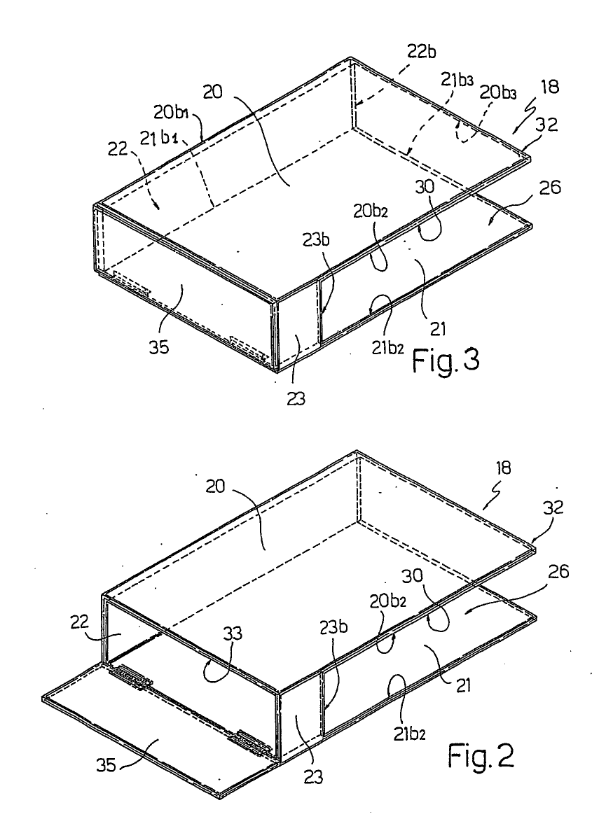

More specifically, lid 35 is movable between a closed position (FIG. 3) perpendicular to walls 20, 21, 22, 23 and closing opening 33, and an open position (FIG. 2) substantially coplanar with wall 21 and opening opening 33, and in which parallelepiped-shaped cavity 26 also communicates with the outside of loading unit 18 through opening 33.

Lid 35 has a fastening device (not shown) which, in use, secures lid 35 firmly in the closed position.

Alternatively, lid 35 may of course be fitted to opening 32 to open/close opening 32, in which case, opening 33 may be dispensed with and replaced with a wall (not shown) of loading unit 18.

Loading units 18 are arranged one on top of another with walls 20, 21 contacting, and with openings 30, 32 facing corresponding sides of conveying unit 5.

Preferably, though not necessarily, the loading units of each conveying unit may be molded in one piece from plastic material.

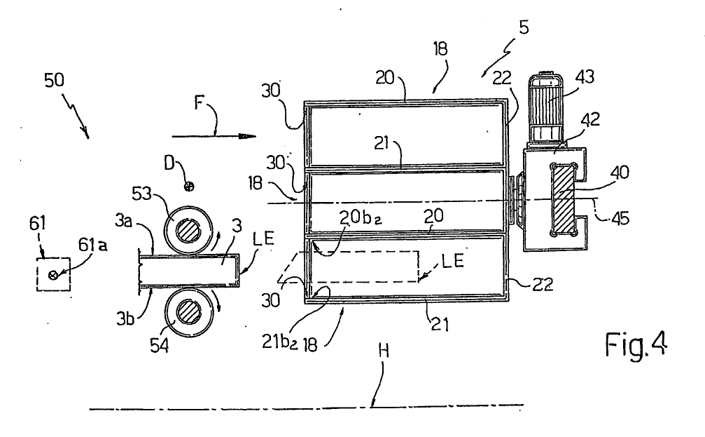

As stated, each conveying unit 5 travels along endless path 7, which may be defined by a rail 40 along which travel powered slides 42 (FIG. 4), each supporting loading units 18 of a respective conveying unit 5.

More specifically, each slide 42 may comprise an electric motor 43 for driving slide 42 along rail 40 and so moving conveying unit 5 along endless path 7; or slides 42 may be driven by powered belts or chains (not shown).

A further electric motor (not shown) is also provided for synchronously rotating loading units 18 about an axis 45 parallel to the horizontal.

More specifically, units 18 can be rotated between a first loading position, in which rectangular openings 30 are positioned with their major sides (edges 20b₂, 21b₂) parallel to a direction D, and with walls 20, 21 parallel to a plane H—in particular, a direction D parallel to the horizontal and to a plane H also parallel to the horizontal; and a second unloading position, in which rectangular openings 30 are positioned with their major sides crosswise—in particular, perpendicular—to direction D, and with walls 20, 21 crosswise—in particular, perpendicular—to plane H.

Device 1 also comprises one or more FLAT feed devices 50 located at loading area 10 and for receiving substantially flat items 3 at the input, and feeding each item 3 into a respective loading unit 18 at the output. The item is inserted in a direction F crosswise—in particular, perpendicular—to direction D, and traveling on a conveying plane substantially parallel to plane H.

FLAT feed device 50 (shown schematically) may comprise two powered rollers 53, 54 positioned with their axes parallel to direction D, and which frictionally engage opposite flat surfaces 3a, 3b of substantially flat items 3.

Rollers 53, 54 are rotated in opposite directions by drive means (e.g. brushless motors not shown) to impart sufficient acceleration to item 3 to hurl it in direction F towards respective unit 18 and through respective opening 30 into parallelepiped-shaped cavity 26. The acceleration imparted to the item is regulated so that item 3 penetrates opening 30 within the available time “window”.

Conveniently, the position of rollers 53, 54 (movable) may be adjusted with respect to the various loading units 18 (fixed) so that rollers 53, 54 feed item 3 through opening 30 of a selected loading unit 18.

Alternatively, the position of loading unit 18 (movable) may be adjusted with respect to rollers 53, 54 (fixed) so that rollers 53, 54 feed item 3 through opening 30 of a selected loading unit 18.

Whichever the case, only one unit 18 of conveying unit 5 is supplied at a time.

Alternatively, a number of rollers 53, 54 (not shown) in different positions (at different heights) may be provided, each for feeding an item 3 through opening 30 of a respective facing unit 18, so as to feed all the loading units 18 of each conveying unit 5 simultaneously.

In actual use, conveying units 5 travel along path 7 to loading area 10. In the example shown, the traveling direction is anticlockwise, though obviously no advantage is lost be employing an opposite (clockwise) traveling direction.

As a unit 18 reaches loading area 10 and nears FLAT feed device 50 (as detected, for example, by a first, e.g. optical, proximity sensor 60), rollers 53, 54 are activated and item 3 is hurled towards rectangular opening 30 positioned with its major sides (edges 20b₂, 21b₂) parallel to direction D.

The position of item 3 is preferably detected by a second proximity sensor 61 (FIG. 4 shows an optical path 61a defined by sensor 61 and interrupted by the passage of item 3) located upstream from rollers 53, 54 in direction F and for detecting the passage of a leading edge LE of item 3.

The position of the item determined by sensor 61 detecting leading edge LE, and the position of loading unit 18 detected by sensor 60, therefore give the position of item 3 with respect to loading unit 18; which information can be used to regulate the way in which item 3 is fed by FLAT feed device 50 (e.g. the acceleration imparted by rollers 53, 54).

Along its path, item 3 is fed in direction F crosswise—in particular, perpendicular—to direction D, and along a plane substantially parallel to walls 20, 21, so that a front end portion LE (shown by the dash line in FIG. 4) of substantially flat item 3 penetrates opening 30 with leading edges LE of item 3 substantially parallel to the major sides of rectangular opening 30 and therefore to edges 20b₂, 21b₂ of the walls of conveying unit 5 traveling in direction D. Substantially flat item 3 is inserted into loading unit 18 through a wide inlet (measured in direction D) so as to clear the walls (23, 21, 20) defining opening 30, even at a high traveling speed of loading unit 18 in direction D.

Loading units 18 may therefore be fed at high speed (e.g. 1 meter/second) along path 7 to achieve a high throughput (e.g. 60,000-80,000-100,000 items/hour) in accordance with the size of conveying unit 5.

Substantially flat item 3 is therefore fed into parallelepiped-shaped cavity 26 without leading edges LE contacting the parts of loading unit 18 defining inlet opening 30, and therefore with no significant rebound and no crumpling of the item.

Leading edge LE of item 3, in fact, comes to rest against wall 22, but does not intersect wall 23 which, if contacted, could shift item 3 crosswise to its traveling direction, thus preventing it from being fed into loading unit 18.

Item 3 is then conveyed along path 7 by conveying unit 5 traveling along rail 40.

As conveying unit 5 leaves loading area 10, loading units 18 are moved into the unloading position (indicated ROT in FIG. 1), e.g. by means of motor 43 or other devices not shown (e.g. cam devices acting on loading units 18), so that substantially flat items 3 lie in planes substantially perpendicular to plane H (i.e. vertical planes), with leading edges LE resting on lids 35 which, in this position, are closed.

On conveying unit 5 reaching unloading area 12, an unloading device (not shown) selectively releases the fastening devices (not shown) of lids 35, so that items 3 fall by gravity from cavities 26 into different unloading containers 14.

As conveying unit 5 leaves unloading area 12, loading units 18 are moved into the loading position (indicated ROT in FIG. 1), e.g. by means of motor 43 or other (e.g. cam) devices not shown, to feed further items 3 into conveying units 5, and lids 35 are again all closed.

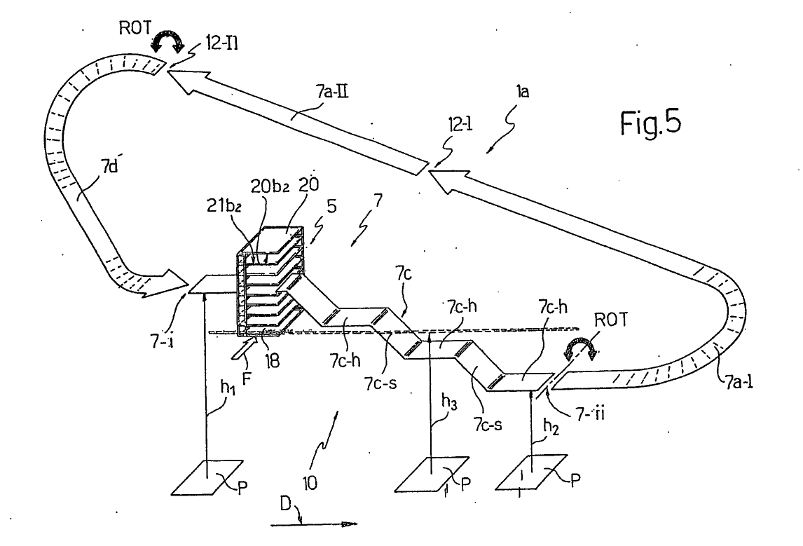

The sorting device la shown in FIG. 5 comprises an endless path 7 extending in a three-dimensional space, as opposed to one plane.

More specifically, conveying units 5 of device 1a comprise a large number of (e.g. eight) loading units 18 with the same structure as those already described.

Loading area 10 comprises a portion 7c of path 7, which extends between a start point 7-i located at a first height h1 with respect to a reference plane P, and an end point 7-ii located at a second height h2 lower than first height h1. Portion 7c of path 7 therefore slopes downwards, in particular in steps, and comprises a number of horizontal portions 7c-h located at different heights and connected by sloping portions 7c-s.

FLAT feed devices 50 (not shown in FIG. 5 for the sake of simplicity) are spaced along portion 7c at the same height h3 with respect to reference plane P.

As conveying units 5 travel along downward-sloping portion 7c, different loading units 18 are positioned facing height h3 at different portions of portion 7c, so that each loading unit 18 is positioned facing, and can be fed with an item 3 by, a respective FLAT feed device 50, thus supplying all the loading units 18 as conveying unit 5 travels along sloping portion 7c.

Sloping portion 7c terminates at a first upward portion 7a-I which terminates at a first unloading area 12-I where first loading units 18 are selectively opened.

More specifically, the items released are fed to a first, e.g. belt, conveying system (not shown) comprising containers (not shown), each for receiving a substantially flat item 3 released by a respective loading unit 18.

Downstream from first unloading area 12-I, first upward portion 7a-I continues in the form of a second upward portion 7a-II which terminates at a second unloading area 12-II where second loading units 18 are selectively opened.

More specifically, the items released are fed to a second, e.g. belt, conveying system (not shown) comprising containers (not shown), each for receiving a substantially flat item 3 released by a respective loading unit 18. Downstream from the second unloading area, second upward portion 7a-II terminates at a downward portion 7d leading back to loading area 10. Along (or upstream from) portion 7d, loading units 18 are rotated so they reach loading area 10 with the major sides of openings 30 aligned with direction D.

Clearly, changes may be made to the device for loading, conveying, and sorting substantially flat items, in particular mail items, as described and illustrated herein without, however, departing from the scope of the present invention.

1) A device for loading, conveying, and sorting substantially flat items (FLATS), in particular mail items (3), comprising at least one loading unit (18) traveling along a path (7) between a loading area (10), where a substantially flat item (3) is fed to the loading unit (18), and an unloading area (12), where the substantially flat item in the loading unit (18) is released; said loading unit (18) defining an inner cavity (26) for receiving and housing said substantially flat item (3); and said inner cavity (26) communicating with the outside of the loading unit (18) through at least one opening (30);
characterized in that said opening (30) is elongated, and is positioned with its major sides substantially aligned with a first traveling direction (D) of said loading unit when the loading unit is located at said loading area (10); said device also comprising a FLAT feed device (50) for feeding a said substantially flat item (3) in a second direction (F) crosswise-in particular, perpendicular-to the first direction (D), so that said substantially flat item (3) is fed into said inner cavity (26) through said elongated opening (30), with leading edges (LE) of said substantially flat item (3) parallel to said major sides of said elongated opening (30).

2) A device as claimed in claim 1, wherein said elongated opening (30) is rectangular.

3) A device as claimed in claim 1, wherein said loading unit (18) comprises at least a first and a second wall (20,21) spaced apart and defining opposite sides of said inner cavity (26); at least one portion each of respective facing straight edges (20b₂, 21b₂) of said first and second wall defining the major sides of said elongated opening (30).

4) A device as claimed in claim 1, wherein said loading unit (18) comprises at least one unloading opening (33) fitted with a lid (35) which is movable between a closed position closing the unloading opening (33), and an open position in which the unloading opening (33) is at least partly accessible; said lid (35) being set, at said unloading area (12), to said open position to enable said substantially flat item (3) to be unloaded from said inner cavity (26) through said unloading opening (33).

5) A device as claimed in claim 1, wherein a number of loading units (18) are connected to form a conveying unit (5) traveling along said path (7).

6) A device as claimed in claim 5, wherein said elongated openings (30) of said loading units (18) extend on the same side of said conveying unit (5).

7) A device as claimed in claim 1, wherein rotation means (43) are provided to rotate said loading unit (18) about an axis of rotation (45); said rotation means rotating said loading unit (18) between a first loading position, in which said elongated opening (30) is positioned with its major sides parallel to said first direction (D), and a second unloading position, in which said elongated opening (30) is positioned with its major sides crosswise-in particular, perpendicular-to said first direction (D).

8) A device as claimed in claim 7, wherein said rotation means (43):
set said loading unit (18) to said first loading position at said loading area (10);
set said loading unit (18) to said second unloading position at said unloading area (12) to unload said substantially flat items by force of gravity; and
restore said loading unit (18) to said first loading position once said substantially flat items (3) are unloaded.

9) A device as claimed in claim 1, wherein said FLAT feed device (50) comprises at least one pair of powered rollers (53, 54) positioned with their axes parallel to the first direction (D), and which frictionally engage opposite flat surfaces (3a, 3b) of a substantially flat item (3);
said rollers (53, 54) being rotated by drive means in opposite directions to accelerate the substantially flat item (3) retained between the rollers, and to hurl it in said second direction (F) towards the elongated opening of said loading unit (18).

10) A device as claimed in claim 9, wherein a number of loading units (18) are connected to form a conveying unit (5) traveling along said path (7);
the position of said pair of powered rollers (53, 54) with respect to the various loading units (18) being adjustable.

11) A device as claimed in claim 10, wherein the position of said pair of powered rollers (53, 54) is fixed, and the position of said conveying unit (5) is adjustable to position a selected loading unit (18) facing said pair of powered rollers (53, 54), and to feed said substantially flat item (3) to said loading unit.

12) A device as claimed in claim 10, wherein the position of said conveying unit (5) is fixed, and the position of said pair of powered rollers (53, 54) is adjustable to position said pair of powered rollers (53, 54) facing a selected loading unit (18), and to feed said substantially flat item (3) to said loading unit.

13) A device as claimed in claim 10, wherein a number of pairs of powered rollers are provided, each pair positioned facing a respective loading unit (18) to feed said substantially flat item (3) to the loading unit.

14) A device as claimed in claim 1, wherein said path is an endless path (7) extending in a three-dimensional space.

15) A device as claimed in claim 14, wherein at least one conveying unit (5) is provided comprising a number of loading units (18) adjacent to one another in one direction;
said path comprising a sloping portion (7c) extending between a start point (7-i) located at a first height (h1) with respect to a reference plane (P), and an end point (7-ii) located at a second height (h2) lower than the first height (h1);
said device (1) also comprising a number of FLAT feed devices (50) spaced along said sloping portion (7c) and substantially at a third height (h3) with respect to the reference plane (P);
as the conveying unit (5) travels along said sloping portion (7c), different loading units (18) are positioned at the third height (h3), so that each loading unit (18) is positioned facing a respective FLAT feed device (50) to receive from it a substantially flat item (3).

16) A device as claimed in claim 15, wherein said sloping portion (7c) terminates at a first upward portion (7a-I) which terminates at a first unloading area (12-I) where first loading units (18) are selectively opened to feed the released substantially flat items to a first conveying system; said first upward portion (7a-I) continuing, downstream from said first unloading area (12-I) into a second upward portion (7a-II) which terminates at a second unloading area (12-II) where second loading units (18) are selectively opened to feed the released substantially flat items to a second conveying system;
said second upward portion (7a-II) terminating, downstream from the second unloading area, at a downward portion (7d) leading back to said sloping portion (7c).

17) A device as claimed in claim 15, wherein said sloping portion (7c) slopes downwards in steps, and comprises a number of horizontal portions (7c-h) located at different heights and connected by sloping portions (7c-s).

18) A device as claimed in claim 1, and comprising:
first sensor means (60) for detecting the approach of said loading unit (18) to said FLAT feed device (50); and
second sensor means (61) for detecting the position of the substantially flat item 83) fed to said FLAT feed device (50);
said device also determining the position of the incoming substantially flat item (3) with respect to the incoming loading unit (18).

19) A method of loading, conveying, and sorting substantially flat items (FLATS), in particular mail items (3), comprising the steps of:
feeding a substantially flat item (3) to a loading unit (18) at a loading area (10);
moving said loading unit to an unloading area (12); and
selectively releasing the substantially flat item from said loading unit;
said loading unit (18) defining an inner cavity (26) for housing said substantially flat item (3) and which communicates with the outside of the loading unit (18) through at least one elongated opening (30);
characterized in that said feeding step comprises the steps of:
positioning said elongated opening with its major sides substantially aligned with a first traveling direction (D) of the loading unit (18); and
